(19) United States
(12) Patent Application Publication
(10) Pub. No.: US 2014/0198496 A1
(43) Pub. Date: Jul. 17, 2014

(54) ILLUMINATION APPARATUS

(71) Applicants: WINTEK (CHINA) TECHNOLOGY LTD., Dongguan City (CN); WINTEK CORPORATION, Taichung City (TW)

(72) Inventors: Zhi-Ting Ye, Miaoli County (TW); Wen-Chieh Wu, New Taipei City (TW); Ming-Chuan Lin, Taichung City (TW); Hung-Pin Chang, Taichung City (TW); Chia-Hung Pan, Taichung City (TW); Hsiu-Ping Lee, Taichung City (TW)

(73) Assignees: WINTEK CORPORATION, Taichung City (TW); WINTEK (CHINA) TECHNOLOGY LTD., Dongguan City (CN)

(21) Appl. No.: 13/740,272

(22) Filed: Jan. 14, 2013

(51) Int. Cl. F21V 5/00; F21V 21/00

(52) U.S. Cl. CPC F21V 5/00; F21V 21/00
USPC 362/235; 362/311.01

(57) ABSTRACT

An illumination apparatus includes a transparent case, an opaque member, a ring-shaped light emitting device, and a ring-shaped transparent cover. The transparent case has a central region. The opaque member is disposed on the central region. The ring-shaped light emitting device is disposed in the transparent case corresponding to the central region. The ring-shaped transparent cover is disposed on the ring-shaped light emitting device and has a first arc-shaped ring portion relatively close to the opaque member and a second arc-shaped ring portion relatively away from the opaque member. A refraction microstructure region is formed on an inner surface of the first arc-shaped ring portion for refracting light emitted by the ring-shaped light emitting device.

### BACKGROUND OF THE INVENTION

1. Field of the Invention

The present invention relates to an illumination apparatus, and more specifically, to an illumination apparatus having a refraction microstructure region formed on an arc-shaped ring portion of its ring-shaped transparent cover relatively close to an opaque member disposed on its transparent case.

2. Description of the Prior Art

In general, a conventional wall-mounted lamp usually has an opaque member (e.g. a metal sheet) disposed on a central region of its transparent case for decoration. If the wall-mounted lamp utilizes a fluorescent tube as a light source, light of the fluorescent tube may be emitted out of a rear opening of a transparent case of the wall-mounted lamp so as to cause a light leak problem since the fluorescent tube has a light emitting angle of 360°. Furthermore, when light of the fluorescent tube directly passes through the central region of the transparent case of the wall-mounted lamp and is then incident into the opaque member, light would be reflected or absorbed by the opaque member so as to reduce the overall amount of light output and the light use efficiency of the wall-mounted lamp.

Although the prior art could utilize a light emitting diode device with a high illumination directivity instead of the fluorescent tube to solve the aforesaid light leak problem, reflection and absorption of light may still occur when light of the light emitting diode device is incident into the opaque member. Thus, no matter which design is utilized, the wall-mounted lamp with the opaque member disposed thereon in the prior art still has a poor efficiency in use of light and a low brightness.

### SUMMARY OF THE INVENTION

An objective of the present invention is to provide an illumination apparatus having a refraction microstructure region formed on an arc-shaped ring portion of its ring-shaped transparent cover relatively close to an opaque member disposed on its transparent case for solving the aforesaid problem.

The present invention provides an illumination apparatus including a transparent case, an opaque member, a ring-shaped light emitting device, and a ring-shaped transparent cover. The transparent case has a central region. The opaque member is disposed on the central region. The ring-shaped light emitting device is disposed in the transparent case corresponding to the central region. The ring-shaped transparent cover is disposed on the ring-shaped light emitting device and has a first arc-shaped ring portion relatively close to the opaque member and a second arc-shaped ring portion relatively away from the opaque member. A refraction microstructure region is formed on an inner surface of the first arc-shaped ring portion for refracting light emitted by the ring-shaped light emitting device.

In summary, the present invention utilizes the design in which the refraction microstructure region is formed on the first arc-shaped ring portion of the ring-shaped transparent cover relatively close to the opaque member, to make the ring-shaped transparent cover capable of having a light refraction effect on the first arc-shaped ring portion, so as to prevent light from being incident into the opaque member. In such a manner, the present invention could efficiently prevent light from being reflected or absorbed by the opaque member, so that the illumination apparatus provided by the present invention could have a preferable efficiency in use of light and a high brightness.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an illumination apparatus according to an embodiment of the present invention.

FIG. 2 is a partial cross-sectional diagram of the illumination apparatus in FIG. 1 along a sectional line A-A′.

FIG. 3 is an exploded diagram of a ring-shaped light emitting device and a ring-shaped transparent cover in FIG. 2.

FIG. 4 is a partial enlarged diagram of the ring-shaped transparent cover in FIG. 2.

FIG. 5 is a brief sectional view of a ring-shaped transparent cover and the opaque member according to another embodiment of the present invention.

### DETAILED DESCRIPTION

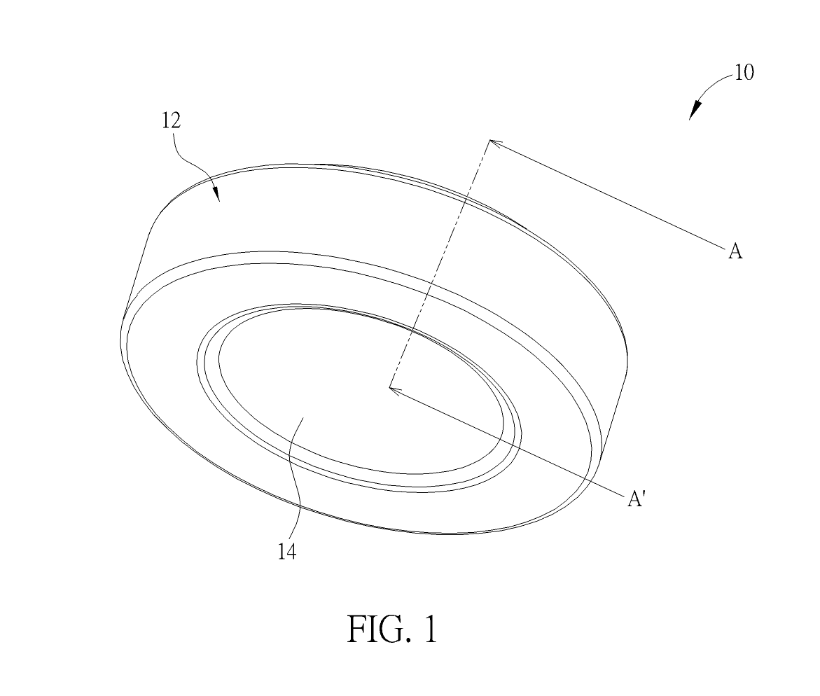

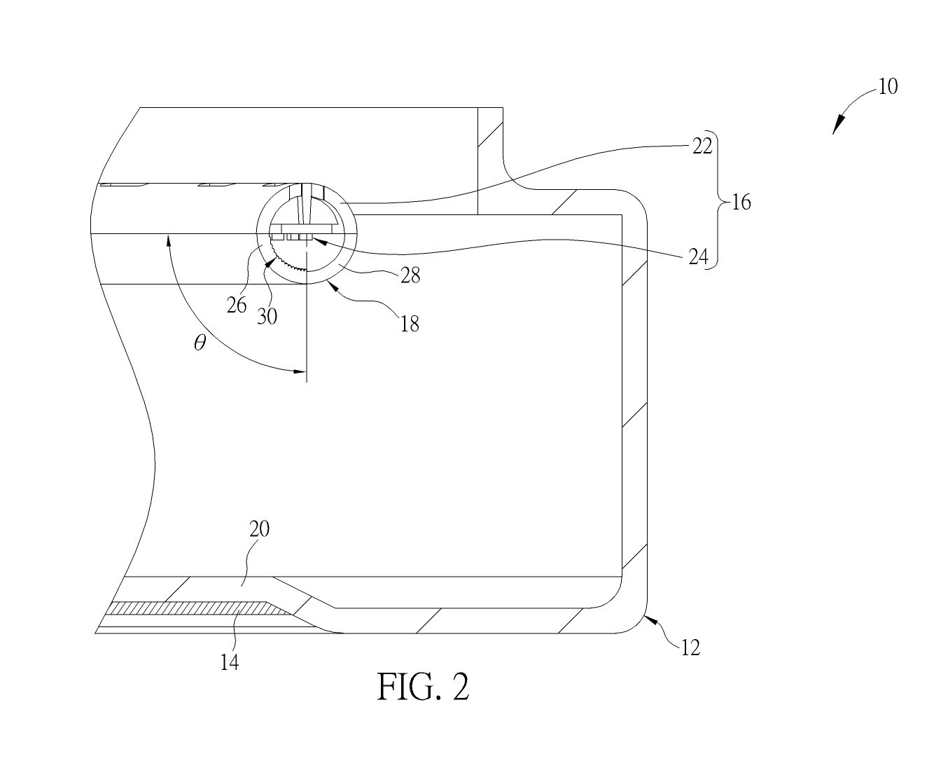

Please refer to FIG. 1 and FIG. 2. FIG. 1 is a diagram of an illumination apparatus 10 according to an embodiment of the present invention. FIG. 2 is a partial cross-sectional diagram of the illumination apparatus 10 in FIG. 1 along a sectional line A-A′. The illumination apparatus 10 could be a wall-mounted lamp, but not limited thereto. As shown in FIG. 1 and FIG. 2, the illumination apparatus 10 includes a transparent case 12, an opaque member 14, a ring-shaped light emitting device 16, and a ring-shaped transparent cover 18. The transparent case 12 could be a conventional lamp casing for containing and protecting a light source disposed therein, and could be preferably made of matt glass material for further enhancing its light scattering effect so as to increase the overall light emitting angle of the illumination apparatus 10. The transparent case 12 has a central region 20. The opaque member 14 could be preferably a metal sheet disposed on the central region 20 for decoration, but not limited thereto.

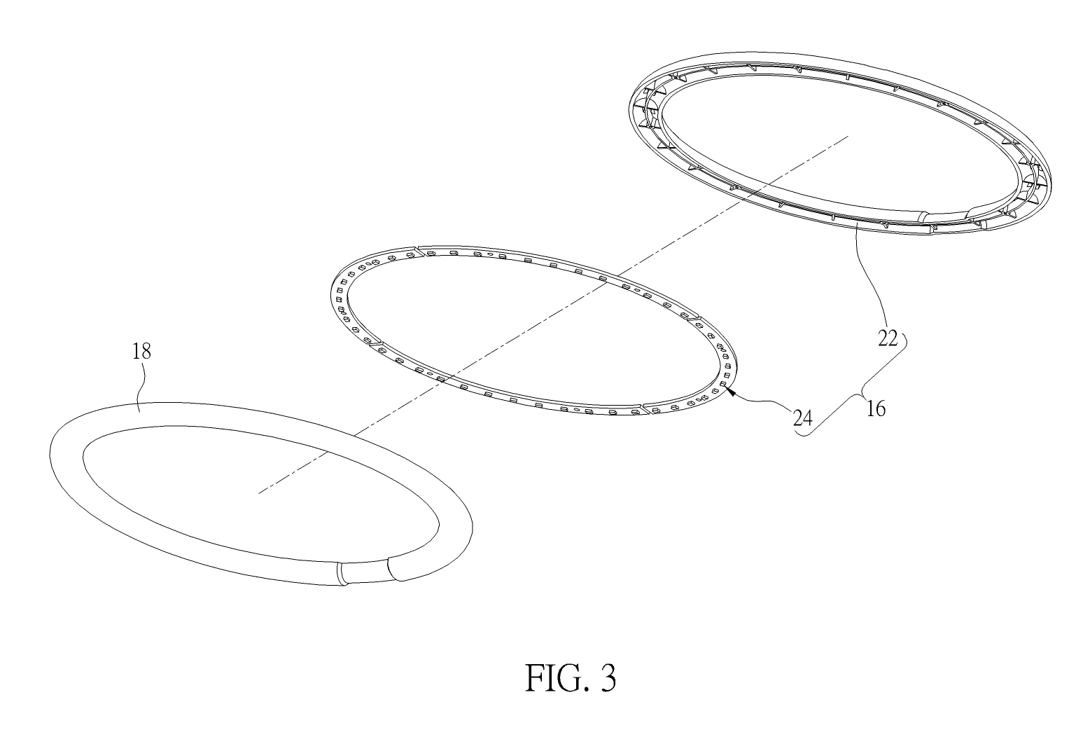

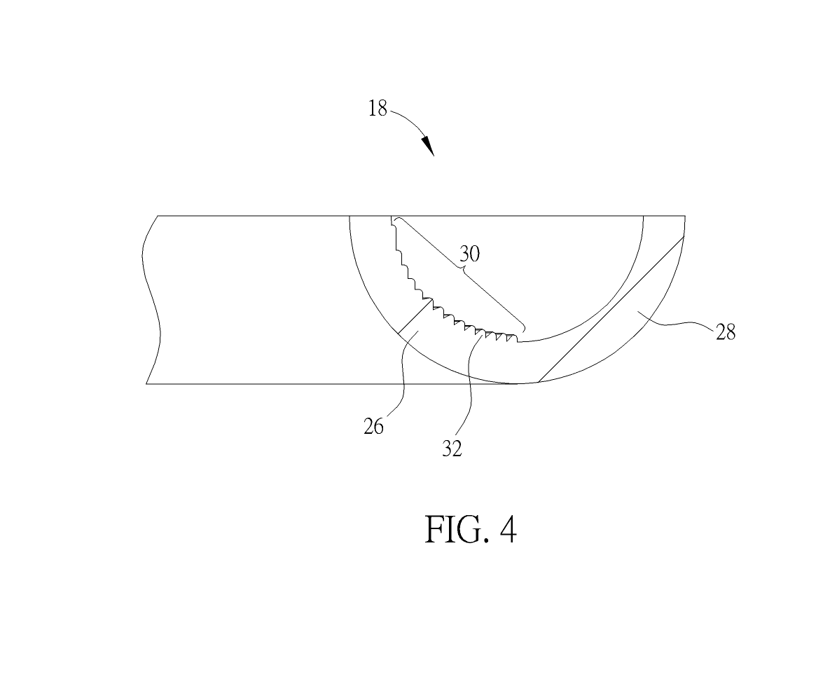

More detailed description for the designs of the ring-shaped light emitting device 16 and the ring-shaped transparent cover 18 is provided as follows. Please refer to FIG. 2, FIG. 3, and FIG. 4. FIG. 3 is an exploded diagram of the ring-shaped light emitting device 16 and the ring-shaped transparent cover 18 in FIG. 2. FIG. 4 is a partial enlarged diagram of the ring-shaped transparent cover 18 in FIG. 2. The ring-shaped light emitting device 16 is disposed in the transparent case 12 corresponding to the central region 20 (as shown in FIG. 2). In this embodiment, the ring-shaped light emitting device 16 could include a ring-shaped holding structure 22 and a plurality of light emitting diodes 24, but not limited thereto. The plurality of light emitting diodes 24 is installed on the ring-shaped holding structure 22 as a light source for emitting light. As for the related description for the installation and circuit designs of the plurality of light emitting diodes 24, it is commonly seen in the prior art and therefore omitted herein.

As shown in FIG. 2, the ring-shaped transparent cover 18 is disposed on the ring-shaped holding structure 22 to cover the plurality of light emitting diodes 24, and has a first arc-shaped ring portion 26 relatively close to the opaque member 14 and a second arc-shaped ring portion 28 relatively away from the opaque member 14. To be more specific, in this embodiment, the first arc-shaped ring portion 26 preferably overlaps with the opaque member 14. A refraction microstructure region 30 is formed on an inner surface of the first arc-shaped ring portion 26 for refracting light emitted by the plurality of light emitting diodes 24. In practical application, the refraction microstructure region 30 includes a central angle θ between 45° and 90° relative to the ring-shaped light emitting device 16, but not limited thereto. That is, the central angular size of the refraction microstructure region 30 depends on the practical illumination application of the illumination apparatus 10.

As shown in FIG. 4, the refraction microstructure region 30 could have a plurality of tooth-shaped ring structures 32 formed thereon. In this embodiment, a vertex angle of the tooth-shaped ring structure 32 relatively close to the second arc-shaped ring portion 28 is less than a vertex angle of the tooth-shaped ring structure 32 relatively away from the second arc-shaped ring portion 28. That is, in this embodiment, the refraction microstructure region 30 has the tooth-shaped ring structures 32 with the gradually-increasing vertex angles between 30° and 90% from a position relatively close to the second arc-shaped ring portion 28.

Via the design in which the refraction microstructure region 30 is formed on the first arc-shaped portion 26 relatively close to the opaque member 14 (as shown in FIG. 2 and FIG. 4), when light emitted by the light emitting diodes 24 is incident into the refraction microstructure region 30, refraction or total reflection of light occurs to guide light to pass through the other region of the transparent case besides the central region 20 instead of directly passing through the central region 20 to be incident into the opaque member 14. Accordingly, since light would not be incident into the opaque member 14, the present invention could efficiently prevent light from being reflected or absorbed by the opaque member 14, so that the light use efficiency and the overall amount of light output of the illumination apparatus 10 could be greatly increased.

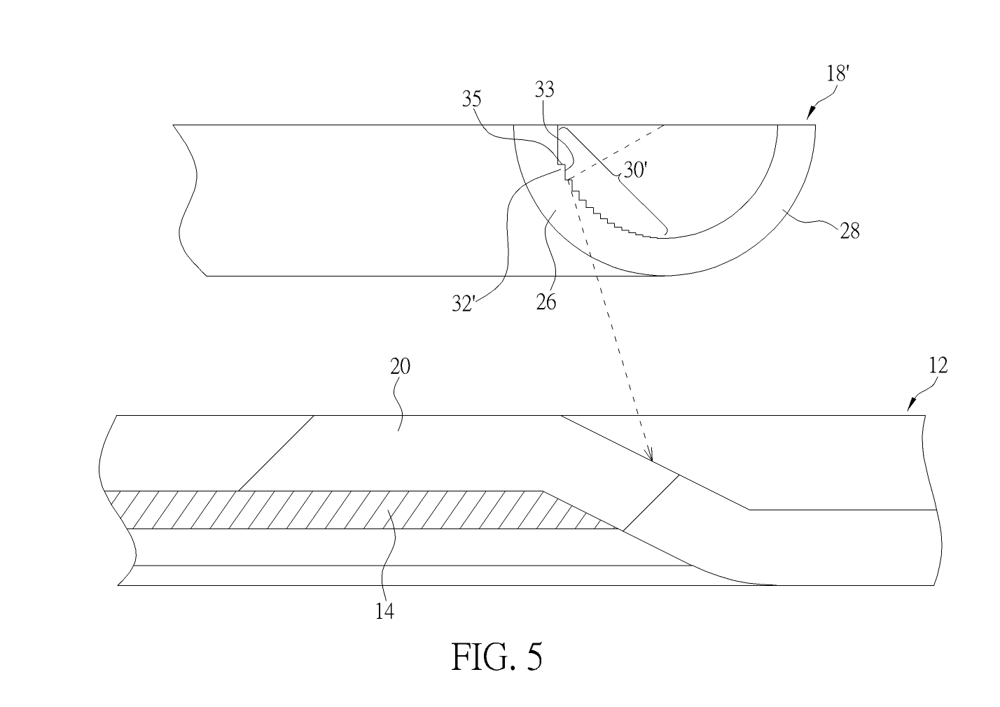

It should be mentioned that the microstructure design of the ring-shaped transparent cover 18 is not limited to the aforesaid embodiment. In other words, all microstructure designs for generating a light refraction effect could be utilized by the present invention. For example, please refer to FIG. 5, which is a brief sectional view of a ring-shaped transparent cover 18′ and the opaque member 14 according to another embodiment of the present invention. Components both mentioned in FIG. 5 and the aforesaid embodiment represent components with similar structures or functions, and the related description is omitted herein. As shown in FIG. 5, the ring-shaped transparent cover 18′ has a refraction microstructure region 30′ formed on an inner surface of the first arc-shaped ring portion 26. The refraction microstructure region 30′ could have a plurality of tooth-shaped ring structures 32′ formed thereon, and each tooth-shaped ring structure 32′ includes two adjacent surfaces 33, 35. In this embodiment, the surface 33 is substantially perpendicular to the opaque member 14, and the surface 35 is substantially parallel to the opaque member 14. Accordingly, when light is incident into the surface 35 parallel to the opaque member 14, refraction of light occurs (as shown in FIG. 5) so as to guide light to be not incident into the opaque member 14. Via the aforesaid design as shown in FIG. 5, the overall light output efficiency of the illumination apparatus 10 could be further improved. Furthermore, in another embodiment, the present invention could also utilize the design in which each tooth-shaped ring structure 32 has the same vertex angle between 30 and 90°. As for which design is utilized, it depends on the practical illumination application of the illumination apparatus 10.

In summary, the present invention utilizes the design in which the refraction microstructure region is formed on the first arc-shaped ring portion of the ring-shaped transparent cover relatively close to the opaque member, to make the ring-shaped transparent cover capable of having a light refraction effect on the first arc-shaped ring portion, so as to prevent light from being incident into the opaque member. In such a manner, the present invention could efficiently prevent light from being reflected or absorbed by the opaque member, so that the illumination apparatus provided by the present invention could have a preferable efficiency in use of light and a high brightness.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An illumination apparatus comprising:
a transparent case having a central region;
an opaque member disposed on the central region;
a ring-shaped light emitting device disposed in the transparent case corresponding to the central region; and
a ring-shaped transparent cover disposed on the ring-shaped light emitting device and having a first arc-shaped ring portion relatively close to the opaque member and a second arc-shaped ring portion relatively away from the opaque member, a refraction microstructure region being formed on an inner surface of the first arc-shaped ring portion for refracting light emitted by the ring-shaped light emitting device.

2. The illumination apparatus of claim 1, wherein the refraction microstructure region has a plurality of tooth-shaped ring structures.

3. The illumination apparatus of claim 2, wherein the plurality of tooth-shaped ring structures has the same vertex angle.

4. The illumination apparatus of claim 3, wherein each tooth-shaped ring structure has a vertex angle between 30° and 90°.

5. The illumination apparatus of claim 2, wherein a vertex angle of the tooth-shaped ring structure relatively close to the second arc-shaped ring portion is less than a vertex angle of the tooth-shaped ring structure relatively away from the second arc-shaped ring portion.

6. The illumination apparatus of claim 5, wherein each tooth-shaped ring structure has a vertex angle between 30° and 90°.

7. The illumination apparatus of claim 1, wherein the refraction microstructure region comprises a central angle between 45° and 90° relative to the ring-shaped light emitting device.

8. The illumination apparatus of claim 1, wherein the ring-shaped light emitting device comprises:
a ring-shaped holding structure; and
a plurality of light emitting diodes installed on the ring-shaped holding structure.

9. The illumination apparatus of claim 1, wherein the transparent case is made of matt glass material.

10. The illumination apparatus of claim 1, wherein the opaque member is a metal sheet.

11. The illumination apparatus of claim 1, wherein the first arc-shaped ring portion overlaps with the opaque member.

12. The illumination apparatus of claim 2, wherein each tooth-shaped ring structure comprises two adjacent surfaces, one of the two adjacent surfaces is substantially perpendicular to the opaque member, and the other one of the two adjacent surfaces is substantially parallel to the opaque member.
